(19) United States
(12) Patent Application Publication
(10) Pub. No.: US 2008/0106468 A1
(43) Pub. Date: May 8, 2008

(54) HIGHLY-ACCURATE RADIO LOCATION OF BEACONS IN A WAREHOUSE

(75) Inventors: John Litva, Almonte (CA); Gunes Z. Karabulut, Ottawa (CA)

Correspondence Address: WORKMAN NYDEGGER, 60 EAST SOUTH TEMPLE, 1000 EAGLE GATE TOWER, SALT LAKE CITY, UT, 84111, US

(73) Assignee: TenXc Wireless Inc., Kanata (CA)

(21) Appl. No.: 11/858,637

(22) Filed: Sep. 20, 2007

(30) Foreign Application Priority Data
Sep. 21, 2006 (CA) 2,558,626

(51) Int. Cl. G01S 3/00

(52) U.S. Cl. 342/451

(57) ABSTRACT

A system for highly accurate radio location of a passive radio beacon coincident with an object to be tracked is disclosed. The beacon directs radio signals to an antenna array located proximate to the warehouse aisles and is positioned such that it receives signals that reflect off the aisle walls grazing angles that are generally less than a maximum, and as such act effectively as mirrors. Ray-tracing techniques may be applied to calculate the response at the antenna array. The multiplicity of reflections may be considered virtual radiating elements setting up a MIMO environment of a plurality of orthogonal modes. Because the location of the beacon is calculated, noise effects can be substantially omitted with an increase in precision of the estimate.

### CROSS-REFERENCE TO RELATED APPLICATIONS

This application claims priority to Canadian Application No. 2,558,626, filed Sep. 21, 2006, which for purposes of disclosure is incorporated herein by specific reference.

### BACKGROUND OF THE INVENTION

1. The Field of the Invention

The present invention relates to radio location of beacons and in particular to an innovative system of radio location for use in a warehouse environment.

2. The Relevant Technology

Modern commercial warehouses are massive structures not unlike well laid-out stand-alone interior urban areas. As shown in exemplary fashion in FIG. 1, tall metal shelves laden with inventory in boxes or on pallets (buildings) tower over long straight aisles (streets), which intersect with one another, along the length and breadth of the building, which may extend on the order of 2 million square feet (approximately 50 acres). These aisles are regularly traversed by a plurality of forklifts and other transport vehicles, often as many as 5000 or more, to move product from one location of the warehouse to another.

With the business world's emphasis on low cost, high volume sales, it is advantageous to plan the paths followed by the forklifts so as to satisfy existing orders but minimize the travel (and the concomitant expense of vehicle fuel and maintenance) and the time required to process the orders. In order to make such plans, it would be helpful to accurately track the location and progress of each vehicle in a real-time environment.

Additionally, inventory control in such warehouses continues to be a significant logistical problem. It is not uncommon for a particular item to remain “lost” within the warehouse for a considerable time, until a manual search can be conducted to locate it, which entails considerable time, effort and expense.

The sheer vastness of the warehouse complex leads to other problems. For example, typically warehouse personnel are provided cordless telephone handsets and/or walkie-talkies to enable communications while on the warehouse floor, and perhaps even laptop computers or personal digital assistants (PDAs) to facilitate the conduct of their various duties. Not infrequently, the warehouse complex is populated by a wireless network that permits e-mail and Internet communication using such devices.

It is, however, not uncommon for such devices to be momentarily set down to attend to a specific task, such as signing a requisition, clearing an obstruction or loading or unloading a pallet. As a result, many of these devices go “missing” and are only re-located, if ever, after the expenditure of considerable time, effort and expense.

Attempts to ensure the location of objects in a warehouse, be they forklifts, inventory or smaller devices, have been made using radio location technology to locate the device by means of active or passive radio beacons, such as RF identification (RFID) tags.

However, radio location in a warehouse poses a difficult technical problem because the warehouse, as a radio environment, is highly stochastic, due to the large preponderance of metal or other highly reflective surfaces (shelving and otherwise) within the warehouse structure and comprising the structure itself.

Such attempts have included dividing a given aisle of a warehouse into a grid, and physically measuring the response within a particular grid location to a generated radio signal in order to compile an empirical radio response profile that can be compared against an actual measured profile in order to provide radio location of the beacon.

However, because of the harsh radio environment, the measured response from one grid element to another, which includes a significant noise component, is known to vary considerably because of the fine scale fading that takes place in the warehouse. The scale size of these variations can be less than one centimetre. Therefore, because of this fine-scale fading the precision of the radio location methodology using such empirical methods is fairly poor and generally unsatisfactory for commercial purposes. In particular, for small lost items such as cordless telephone handsets and the like, the size of the grid element still mandates a fairly long search to locate the item within the identified grid element.

Moreover, such prior art methods do not attempt radio location in three dimensions. Rather, location is limited to the horizontal plane, with no attempt to estimate the height of the beacon.

Additionally, because of the considerable size of commercial warehouses, the effort involved in identifying the measured response for all grid elements within the warehouse, even with the large grid element size, poses a formidable and expensive task.

Moreover, the configuration of the warehouse will be changed on occasion. While one can implement machine learning techniques to correct for the physical changes that take place in the warehouse using the prior art method of measuring the anticipated response in each grid element, every time the configuration of the warehouse is altered, even in a small respect, it is conceivable that the measurement task will be repeated, if for no other reason than to confirm that the anticipated response has not been significantly altered.

### SUMMARY OF THE INVENTION

Accordingly, it is desirable to provide a method and system for locating and tracking the position of a passive radio beacon within a warehouse to a precision of a fraction of a metre.

It is further desirable to provide a method of locating and tracking the position of a passive radio beacon within a warehouse that is low-cost and easy to implement and to modify as the configuration of the warehouse is altered.

The present invention accomplishes these aims by providing a theoretical model for the radio channel defined by the aisles of the warehouse that is easily calculable in real-time. The model obviates the need for any set-up or pre-measurement of anticipated responses, as the preferred response can be calculated in accordance with the model.

Additionally, because the anticipated responses of the grid can be calculated rather than merely measured, a higher correlation may be obtained between an actual measured return and the anticipated response, so that the size of the grid elements can be significantly reduced, resulting in greatly increased precision in the radio location exercise.

Further precision may be obtained by generating a radio signal along a plurality of frequencies and measuring the response obtained in respect of each transmitted frequency.

The increased precision and greater simplicity makes it possible to implement the method and system to track not only forklifts, but all inventoried materials and even smaller items such as cordless telephone handsets, laptops and PDAs. Conceivably, if warehouse personnel are suitably tagged, they too could be tracked throughout the warehouse using the inventive method and system.

The technology required to implement the inventive system is minimal and generally low-cost and in many warehouse environments, may already be implemented to some degree.

The inventive technique may also find application in non-warehouse environments, including potentially in a dense urban environment and provides a novel, inexpensive and sufficiently precise method and system for locating individuals and objects in such environments. For example, the technique may be applied to cellular telephone handsets to provide an inexpensive means of tracking individuals throughout a dense urban area, with little or no requirement for additional equipment or infrastructure.

According to a first broad aspect of an embodiment of the present invention, there is disclosed a system for accurately determining a location of an object in an aisle, the aisle being defined by a plurality of surfaces, the system comprising:
an antenna array located proximate to the aisle;
a beacon coincident with the object, for directing a radio signal to the antenna array along at least one path that reflects off at least one of the surfaces at a grazing angle that is less than a maximum grazing angle, to form, with a path extending directly from the beacon to the antenna array, a plurality of orthogonal modes;
a processor operatively coupled to the antenna array, for determining the location of the beacon by:
(a) dividing at least a portion of the aisle into a grid of elements;
(b) applying an object function to the orthogonal modes received by the antenna array from the beacon;
(c) for each element in the grid:
   i. calculating a signal that approximates a plurality of orthogonal modes that would be received by the antenna array if the beacon were situated within the element;
   ii. applying the object function to the calculated signal for the element; and
   iii. correlating the object function of the received orthogonal modes with the object function of the calculated signal for the element;
(d) identifying the element for which the object function of the calculated signal corresponding thereto most closely correlates with the object function of the received orthogonal modes; and

determining the location of the object to be within the boundaries of the identified element of the grid.

According to a second broad aspect of an embodiment of the present invention, there is disclosed a method for accurately determining a location of an object in an aisle, the aisle being defined by a plurality of surfaces, the method comprising the steps of:
(a) directing a radio signal from a beacon coincident with the object to an antenna array located proximate to the aisle along at least one path that reflects off at least one of the surfaces at a grazing angle that is less than a maximum grazing angle, to form, with a path extending directly from the beacon to the antenna array, a plurality of orthogonal modes;
(b) applying an object function to the orthogonal modes received by the antenna array from the beacon;
(c) dividing at least a portion of the aisle into a grid of elements;
(d) for each element in the grid:
   i. calculating a signal that approximates a plurality of orthogonal modes that would be received by the antenna array if the beacon were situated within the element;
   ii. applying the object function to the calculated signal for the element; and
   iii. correlating the object function of the received orthogonal modes with the object function for the calculated signal for the element;
(e) identifying the element for which the object function of the calculated signal corresponding thereto most closely correlates with the object function of the orthogonal modes; and
(f) determining the location of the object to be within the boundaries of the identified element of the grid.

According to a third broad aspect of an embodiment of the present invention, there is disclosed a processor operatively coupled to an antenna array located proximate to an aisle, for locating an object in the isle, the aisle being defined by a plurality of surfaces, comprising:
(a) an allocator for dividing at least a portion of the aisle into a grid of elements;
(b) a receive processor for receiving from a beacon coincident with the object, a radio signal directed to the antenna array along at least one path that reflects off at least one of the surfaces at a grazing angle that is less than a maximum grazing angle, to form, with a path extending directly from the beacon to the antenna array, a plurality of orthogonal modes;
(c) a simulator for calculating a plurality of signals that each approximate a plurality of orthogonal modes that would be received by the antenna array if the beacon were situated within a corresponding one of each of the elements;
(d) a characterizer for applying an object function to the orthogonal modes and each of the plurality of calculated signals; and
(e) a correlator for correlating the object function of the orthogonal modes with the object function of each of the calculated signals and identifying the element for which the object function of the calculated signal corresponding thereto most closely correlates with the object function of the orthogonal modes;

whereby the location of the object is determined to be within the boundaries of the identified element of the grid.

According to a fourth broad aspect of an embodiment of the present invention, there is disclosed a computer-readable medium in a processor operatively coupled to an antenna array located proximate to an aisle, for locating an object in the aisle, the aisle being defined by a plurality of surfaces, the medium having stored tehreon, computer-readable and computer-executable instructions which, when executed by a processor, cause the processor to perform steps comprising:
(a) directing a radio signal from a beacon coincident with the object to the antenna array along at least one path that reflects off at least one of the surfaces at a grazing angle that is less than a maximum grazing angle, to form, with a path extending directly from the beacon to the antenna array, a plurality of orthogonal modes;
(b) applying an object function to the orthogonal modes received by the antenna array from the beacon;
(c) dividing at least a portion of the aisle into a grid of elements;
(d) for each element in the grid:
   i. calculating a signal that approximates a plurality of orthogonal modes that would be received by the antenna array if the beacon were situated within the element;
   ii. applying the object function to the calculated signal for the element; and
   iii. correlating the object function of the received orthogonal modes with the object function for the calculated signal for the element;
(e) identifying the element for which the object function of the calculated signal corresponding thereto most closely correlates with the object function of the orthogonal modes; and
(f) determining the location of the object to be within the boundaries of the identified element of the grid.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a line-drawing of an exemplary warehouse location such as would benefit from the application of the present invention;

FIG. 2 is a floor plan of an exemplary warehouse layout in which an embodiment of the present invention maybe implemented;

FIG. 3 is a plan view representation of a model of propagation down an aisle of the warehouse layout of FIG. 2;

FIG. 4 is an exemplary geometrical construct used to illustrate the effects of higher-order image signals due to reflections from the side walls and the floor of an aisle;

FIGS. 5a and 5b are graphs of orthogonal modes set up in the exemplary construct of FIG. 3;

FIG. 6 is a flowchart of the methodology of a correlation-based detection and location algorithm in accordance with an embodiment of the present invention;

FIG. 7 is a graph of interference patterns that may be discerned, as a function of distance along an aisle, for beacon heights of 10 m and 10.25 m, in accordance with the exemplary construct of FIG. 3;

FIG. 8 is a plot of contours of constant phase differences modulo 180° in accordance with the exemplary construct of FIG. 3;

FIG. 9 is a graph of interference patterns that may be discerned, as a function of the height of a beacon, in accordance with the exemplary construct of FIG. 3;

FIG. 10 is a graph of interference patterns that may be discerned as a function of the distance from a beacon in two dimensions (x, z), in accordance with the exemplary construct of FIG. 3;

FIG. 11 is a plan view of an experimental layout in accordance with an exemplary embodiment of the present invention;

FIG. 12 is a plot of the measurement results from the exemplary layout of FIG. 11;

FIG. 13 is a plot of the power delay and angle of arrival (AOA) measured by the experimental layout of FIG. 11;

FIG. 14 shows an exemplary simulated path of a beacon along an aisle of a warehouse; and

FIG. 15 is a graph of the cumulative probability distributions for error in each of the x- and y-directions in the exemplary simulation of FIG. 14.

### DETAILED DESCRIPTION OF THE PREFERRED EMBODIMENTS

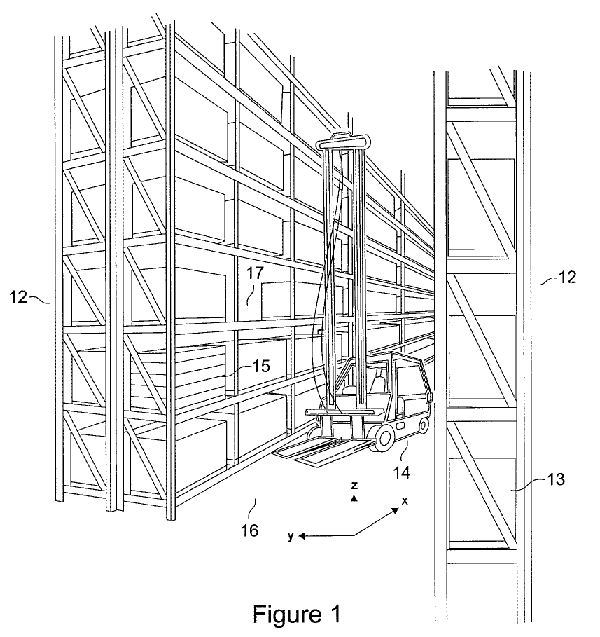

FIG. 1 illustrates a typical warehouse set up. There are shelving units 12 placed throughout the warehouse to form aisles 16. The shelves 12 are typically fully or partially laden with merchandise that are placed in cardboard boxes 13, which may be wrapped in plastic. Occasionally some of the shelves 12 are empty 17. The merchandise is collected by a forklift 14.

The shelves 12 extend vertically to a range of heights, according to the warehouse application. In the exemplary embodiment shown, a typical height of 10 m is used.

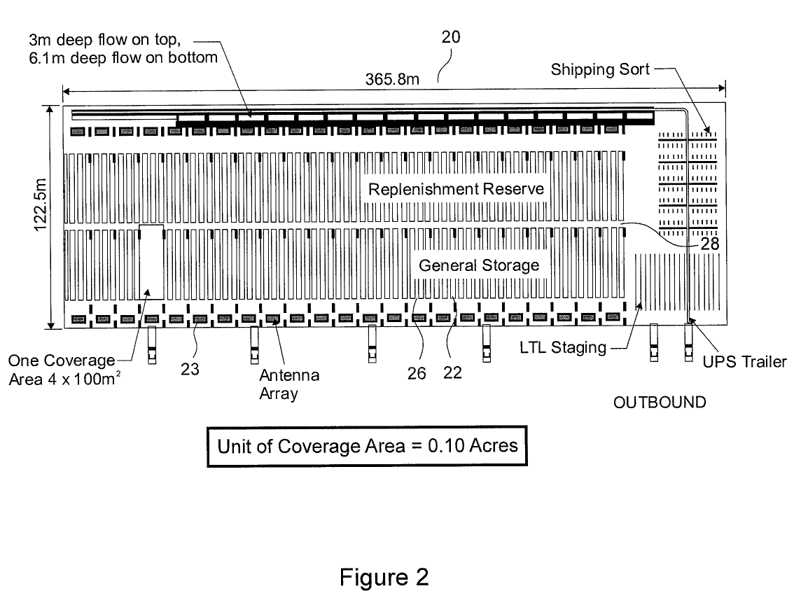

Referring now to FIG. 2, there is shown an exemplary layout of a floor plan 20 of a warehouse in which the present invention is implemented. Typical warehouses may extend over many acres.

The warehouse comprises a plurality of longitudinal aisles 26, each defined by a pair of rows of shelves 22, each of which may comprise a single relatively continuous shelf or else a series of co-linearly positioned shelves in relatively close proximity. Typically, such shelves 22 extend from the floor to the roof of the warehouse structure such that forklift 14 and other transport devices are used to access inventory loaded on the uppermost shelves 22 and lower them to ground level for processing or for transport. In addition, the fact that the shelves 22 extend from floor to roof means that the shelves 22 along either side of an longitudinal aisle 26 may act as two parallel plates trapping radio waves propagating therealong, until they reach one or the other end of the longitudinal aisle 26. The longitudinal aisles 26 are of a sufficient width that at least one forklift 14 may easily traverse the longitudinal aisle 26, turn within the longitudinal aisle 26 and load and unload inventory from one of the shelves 22 defining the longitudinal aisle 26. Typically, such longitudinal aisles 26 are up to 150 m in length and may be 4 m wide. For ease of description, the direction along which the longitudinal aisle 26 extends will be denoted the x-direction and the transverse (in the horizontal plane) direction will be denoted the y-direction for a given aisle. The vertical direction is denoted the z-direction.

A plurality of transverse aisles 28 may also be defined by a larger relatively constant spacing between adjacent shelves 22 along an aisle wall, so that the transverse aisle's 28 width approximates that of the longitudinal aisles 26, which may be 4 m. These latter aisle ways may be virtual rather than real. Even in virtual aisle ways the process will be able to determine the radio wave propagation and create a radio image which will locate objects.

As is discussed below, each aisle, whether longitudinal 26 or transverse 28, is notionally divided into a two-dimensional grid. The dimension of each grid element is determined based upon the desired resolution accuracy. There is a one-to-one relationship between resolution and grid spacing. For example a one centimetre resolution calls for a grid spacing of one centimetre.

At one end of each longitudinal 26 and transverse aisle 28 there is situated an antenna array 23. The antenna array 23 is situated at a height which may be 10 m for exemplary purposes. The inventive technique works independently of the height the antenna array 23, which may be wall, floor or ceiling-mounted, so long as the height of the antenna array 23 is known. The system's performance improves with the antenna array 23 height, because there is a longer propagation path length, thereby reducing the effect of local irregularities, such as under populated shelves. Preferably, the antenna array 23 is high enough to minimize blockage by forklifts or other impediments.

Most preferably, the antenna array 23 is ceiling-mounted for several reasons. First, if ceiling-mounted, there is a reduced likelihood that the delicate antenna array 23 components will be contacted or obstructed by personnel, vehicles or inventory.

Second, given that, as explained below, there may exist a minimum distance from the antenna array 23 below which the grazing angle is so large that the inventive technique does not work, some or all of this minimum distance may be taken up by the height difference between the antenna array 23 and a nearby but typically low-hanging beacon 34.

Preferably, the antenna array 23 is a multi-element array, for instance a 4×1 element array or more preferably, a 4×4 element array. The number of elements in each antenna array 23 determines to some extent the effective distance over which the inventive radio location technique described herein may be applied.

Calculations estimate that for a 4-element array, the coverage would be in the order of 4×100 m2 or approximately 0.10 acres. With a 5×4 element array, a coverage area of about half an acre would be feasible. In order to cover a warehouse of about 46 acres (2 million square feet), approximately 460 4×1 or 4×4 arrays would be required. Presumably there would be a sufficient number of aisles 26, 28 in a warehouse of this size to account for the required number of antenna arrays 23. If not, however, then additional antenna arrays 23 may be positioned at other positions in the aisle 26,28, for example at opposite ends thereof, or midway down the length of a particularly long aisle 26,28.

The number of antenna arrays 23 used required to service a warehouse may be determined, on the basis of these area calculations, taking into account the exemplary four meter width and 100 m length of each aisle 26,28 using the inventive technique.

Each object whose position is to be tracked has an associated reflective beacon 34 suitably attached thereto. Each beacon 34 provides some identifying information that will serve to differentiate it from other beacons 34. The beacon 34 is capable of operating at a plurality of frequencies. Preferably, the beacon 34 is an active radio frequency (RF) identification (RFID) tag or transponder containing an antenna to enable it to receive and respond to RF queries from an RFID transponder.

Still more preferably, the beacon 34 comprises a Wi-Fi equipped wireless data terminal such as a Wi-Fi enabled laptop or PDA. In this case, no additional expense need be incurred for beacons 34 in order to implement the inventive technique.

The antenna array 23 responds to and receives radio signals emanating from one or more of the beacons 34. In the present preferred embodiments, the beacons 34 are active radio beacons or RFID tags. However, it is contemplated that the inventive method could be applied to passive RF reflective beacons, in the presence of an independent radiating source. Preferably, the radiating source may be the series of Wi-Fi pilot tones, typically at 2.4 GHz, or perhaps even as low as 800 MHz, such as would be used to transmit from a wireless data terminal serving as the beacon 34 throughout the warehouse.

In any event, some care may be taken to ensure the appropriate positioning of the beacon 34 on the object. For example, with a forklift 14, it may be advantageous to place the beacon 34 on the front of the lift portion itself, so that the location that is being tracked is not just of the position of the forklift 14 along the floor plan of the warehouse, but also the height at which the lift portion is extended.

The present invention is based upon the recognition that virtual beacons (defined by ray tracing of reflections off the “walls” of an aisle 35,36 passing from the beacon 34 to the antenna array 23) constitute orthogonal modes are set up as radio waves propagate down an aisle 26,28 and are coherently reflected by the sides of the shelves 22.

The beacon 34, along with its reflected virtual image sources, appears to form a virtual array or a network of interferometers, and thus, with the antenna array 23, has a topology consistent with that of Multiple Input Multiple Output (MIMO) systems.

Even though the shelving 12, with or without its inventory is properly considered to form a rough scattering surface, when a radio signal impinges upon it at a low grazing angle (that is the angle formed by the shelving “wall” and the incoming radio signal), as would be the case in a warehouse aisle 26,28, the shelving “surface” appears smooth to radio wave frequencies.

The demarcation between diffuse and specular scattering is given by the critical height, hc,

$${h}_{c} = \frac{λ}{8 sin {θ}_{i}} \qquad ( 1 )$$

where λ is the radio wavelength and θᵢ is the grazing angle.

Equation (1) demonstrates that the surface height perturbations corresponding to a θᵢ of 1° is h_{c} of 0.9 m. Thus, if the perturbation in the location of the boxes 13 in the shelving 12 is less than 0.9 m for an aisle 26,28 in which the steepest grazing angle is 1°, the surface will appear to be perfectly smooth to the wave reflected by the wall of shelving.

The exemplary requirement of a grazing angle of 1° could be achieved, for instance, for a typical warehouse aisle 26,28 150 m in length, by an aisle 26,28 spacing of 2.6 m. Put another way, if one were to determine that the maximum grazing angle above which the simplifying assumption would cease to have application was 0.4 radians or about 23°, for an aisle width of 4 m, the minimum effective range would be about 10 m. As indicated previously, some of this distance may be taken up by the height difference between the antenna array 23 and the beacon 34.

In any event, alternative triangulation means can be employed for beacons 34 positioned in these regions adjacent to the antenna arrays 23. For example, one may place additional antenna arrays 23 at opposite ends of the aisle 26,28.

Because of the low grazing angle, for all intents and purposes, the walls of the aisles 35,36 are smooth reflectors and can be treated as mirrors at radio frequencies. Geometrical or ray optics can thus be derived from Maxwell's Equations as an asymptotic solution obtained in the limit as the frequency approaches infinity.

The theory is developed by assuming that the fields can be expanded as a power series in inverse powers of the radian frequency ω. Geometrical optics is generally a valid approximation when the index of refraction changes slowly over a distance that is large compared with the wavelength and when the antenna apertures are many wavelengths in size, such as in the case of reflection off walls of an aisle 35,36 at low grazing angles.

In view of the foregoing, the aisles 26,28 of the warehouse, or for that matter, a store or distribution centre can be effectively treated as a parallel plate waveguide, so that signals propagating down the aisle from a beacon 34 to an array antenna 23 may be used to determine the location of the beacon 34 to an accuracy of less than 1 m. The signals received at the antenna array 23 are orthogonal to one another in that each entity in the series will have a different amplitude and/or phase and thus constitute a different transverse electromagnetic mode (TEM), and are easily separated in angle-of arrival (AOA) or time-of-arrival.

There can be many different signals that propagate down an aisle 26,28, resulting in a chaotic signaling environment that borders on total discord. However, although the warehouse electromagnetic environment is random and noisy, the known signatures (power series) for the orthogonal modes can be exploited to detect a beacon 34 and to estimate its location. A spatial filter may be used to filter out the random-like signals and only receive the desirable deterministic signals.

The present invention makes use of the a priori knowledge by the system of the characteristics of the signals of interest and that they consist of a sequence of orthogonal modes. By performing a search for the right set of orthogonal modes by correlating the measured signals with simulated signals, each set of which are unique and correspond to candidate locations along the aisle 26,28, the received signals may be associated with one of the candidate locations, thus providing a location for the beacon 34.

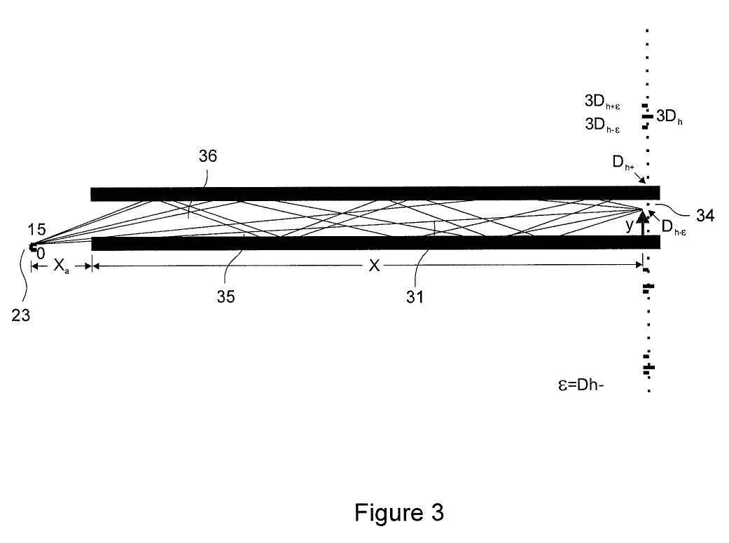

This phenomenon is shown graphically in FIG. 3, in which the walls of the aisle 35,36 are treated as mirror-like reflecting surfaces for the radio signals 31 emanating from the beacon 34.

Turning now to FIG. 3, a direct signal from a beacon 34 to an antenna array 23 is shown as a single line connecting the two objects 31. In reality, it is composed of a direct through-the-air signal and a signal reflected from the warehouse floor.

The vector sum of these two signals is proportional to the sum of a unit vector and a reflected signal, whose amplitude is reduced by the magnitude of the reflection coefficient and whose phase relative to the unit vector is equal to the phase of the reflection coefficient, combined with the phase due to the path length difference between the direct and reflected signals.

Thus, it will be seen that the effective range of the inventive technique relates to the reflection coefficient and the concomitant attenuation of the reflected orthogonal modes.

As the path length difference varies between modulo λ/2, a null is manifested in the interference pattern and when the path length difference is modulo λ, a peak is observed in the interference pattern.

The Fresnel reflection coefficients for reflections for parallel and perpendicular polarized waves are, respectively,

$$\begin{matrix}{ρ}_{‖} = \frac{- ɛ \cdot sin θ + \sqrt{ɛ - {cos}^{2}} θ}{ɛ \cdot sin θ + \sqrt{ɛ - {cos}^{2} θ}} \\ and & ( 2 ) \\ {ρ}_{⊥} = \frac{sin θ - \sqrt{ɛ - {cos}^{2} θ}}{sin θ + \sqrt{ɛ - {cos}^{2} θ}} & ( 3 )\end{matrix}$$

where:

ρ_{∥} is the parallel reflection coefficient,

p [symbol] is the perpendicular reflection coefficient,

θ is the angle of incidence, and

∈ is the dielectric constant.

The electric field at the antenna array 23 due to interference between the direct and floor reflected signals is

$$e = ( \frac{{ⅇ}^{- j kD}}{4 π D} ) \cdot [ 1 + {ρ}_{⊥} \cdot {ⅇ}^{- j k Δ} ] \qquad ( 4 )$$

where: D=distance between the beacon 34 and the antenna array 23,

$$k = \frac{2 π}{λ} = phase constant ,$$

h1=height of the antenna array 23,

h2=height of the beacon 34, and

Δ=path length difference (approximated by

$$\frac{2 \cdot h 1 \cdot h 2}{D} ,$$

when (h1+h2)>>D.

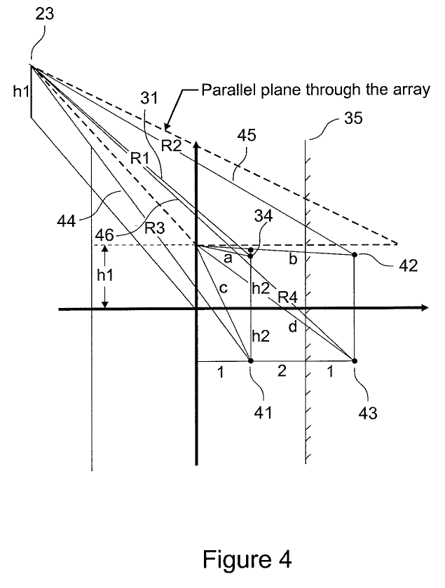

FIG. 4 provides a geometrical construct that allows the inclusion of more of the images in the calculation of an interference pattern, as discussed below.

The quantities in FIG. 4 are summarized as follows:
a=\sqrt{1²+(h1−h2)²} (5)
R1=\sqrt{a²+150²} (6)
b=\sqrt{(h1−h2)²+3²} (7)
R2=\sqrt{(h1−h2)²+4²+150²} (8)
c=\sqrt{1²+(h1+h2)²} (9)
R3=\sqrt{1²+(h1+h2)²+150²} (10)
d=\sqrt{4²+(h1+h2)²} (11)
R4=\sqrt{4²+(h1+h2)²+150²} (12)

As can be seen from FIG. 4, ray optics postulate that for each point source of radiation (the beacon) 34 within the waveguide (the shelves along the aisle 35, 36) a notional additional point source 41,42 emanates from the other side of each mirror (e.g., 35), which also generates waves received by the antenna array 23. Each of these notional point sources in turn may have waves that reflect off the other mirror-like surface 36, again modeled by a further notional point source 43 on the other side of the second surface.

As a result of the foregoing, a plurality of notional point sources 41,42,43 may be seen to generate wavefronts that impinge upon the antenna array 23.

The expression that includes the first wall image and its floor image is given by:

$$e 5 = ( \frac{{ⅇ}^{- j \cdot k \cdot D}}{4 \cdot π \cdot R} ) \cdot [ 1 + {ρ}_{⊥} \cdot {ⅇ}^{- j \cdot k \cdot Δ 2} + {ρ}_{‖} \cdot {ⅇ}^{- j \cdot k \cdot Δ 3} + {ρ}_{‖} \cdot {ρ}_{⊥} \cdot {ⅇ}^{- j \cdot k \cdot Δ 4} ] \qquad ( 13 )$$

The first term in the second set of brackets in Equation (13) represents the direct signal (R1) 31. The second term is the floor-reflected signal (R3) 44, the third term is the wall-reflected image (R2) 45 and the last term is the floor-reflected image of the wall-reflected image (R4)46.

Δ2, Δ3 and Δ4 are respectively, the path length differences with respect to the direct signal 31, the first floor-reflected signal 44, the first wall-reflected signal 45 and the floor-reflected signal corresponding to the wall-reflected signal 46. Other families of images can be treated similarly to those in Equation (13).

A very useful and easily understood method of analyzing optical problems is known as geometrical optics or ray optics. The relationship between ray optics and wave propagation is well-known.

Since the early 1950s, these methods of optics have found increasing use in the treatment of many electromagnetic problems in the radio frequency portion of the spectrum for situations where the wavelength is small compared to the geometrical dimensions of a scatterer or antenna. Those having ordinary skill in this art refer to an object that covers less than the Fresnel zone as a scatterer, because it is scattered rather than reflected.

In such situations, asymptotic high-frequency methods must be employed since it is not practical to use moment methods or eigenfunction expansions. This is because the rate of convergence of both of these techniques is generally quite poor when dealing with electrically large antennas and/or scatterers.

Geometrical optics, or ray optics, as it is often called, were originally developed to analyze the propagation of light where the frequency is sufficiently high that the wave nature of light need not be considered. Indeed, geometrical optics can be developed by considering the transport of energy from one point to another without any reference for whether the transport mechanism is particle or wave in nature.

In view of the foregoing, ray tracing calculations may be applied to determine the anticipated response at the antenna array 23 of a radio signal emanating from a beacon 34 at a point within each of the identified grid elements along each aisle 26,28.

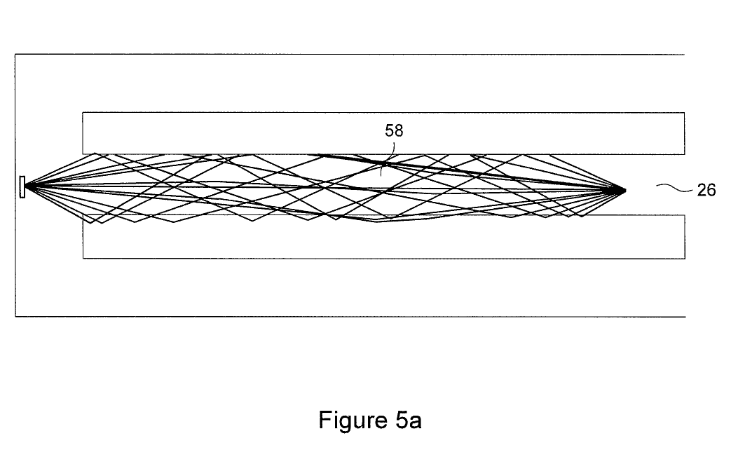

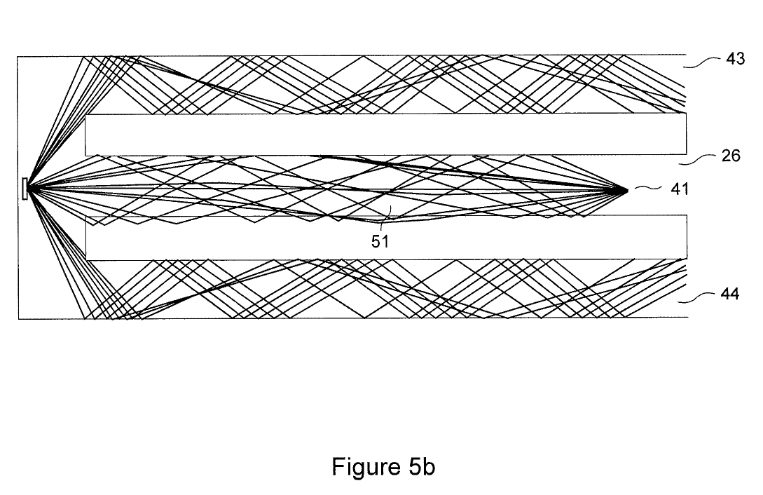

FIG. 5(a) shows the output of the Wireless Insite tracing software program by Remcom, showing the establishment of orthogonal modes 58 set up by reflection in an exemplary scenario in which the shelves 12 defining a longitudinal aisle 26 were filled with pallets of merchandise 13 and in which the shelves 12 have no pallets of merchandise 17.

FIG. 5(b) shows the output of the ray-tracing software showing the establishment of orthogonal modes 51 where there are a plurality of modes of propagation down multiple longitudinal aisles 26, originating from a plurality of beacons 34.

The angle of arrival (AOA) of the waves generated by the actual and notional (reflected) point sources 41,42,43 may be detected by the antenna array 23, which may optionally apply beam-forming techniques to generate a plurality of beams for increased AOA precision.

The algorithm that is used to detect and locate the beacon 34 consists of a deterministic model of waveguide mode propagation in the aisle 26,28 and the implementation of an object function based upon Equation (13) and its analogous families, along with appropriate correlation functions.

Normally, one only uses a four-element array for carrying out the radio location. This is true, despite the fact that an antenna array 23 of this size typically cannot resolve the AOAs of the orthogonal modes. This is because the very small (typically <1° differences in AOA cannot be differentiated by an antenna array 23 whose length is less than 50λ or 6.2 m. However, if an identified function is sensitive to the phases of the modes, this object function 64 could be used in a correlation process as discussed below to achieve greater accuracy. A super-resolution algorithm has been developed, whose resolving capability is less than the Rayleigh limit. According to the Rayleigh limit an antenna whose aperture is L can only separate two signals if their AOA differs by more than λ/L radians or 19° in the case of a 4-element antenna array 23. With the inventive super-resolution algorithm, two sources separated by only 0.08° which is 240 times greater than the Rayleigh limit, may be differentiated.

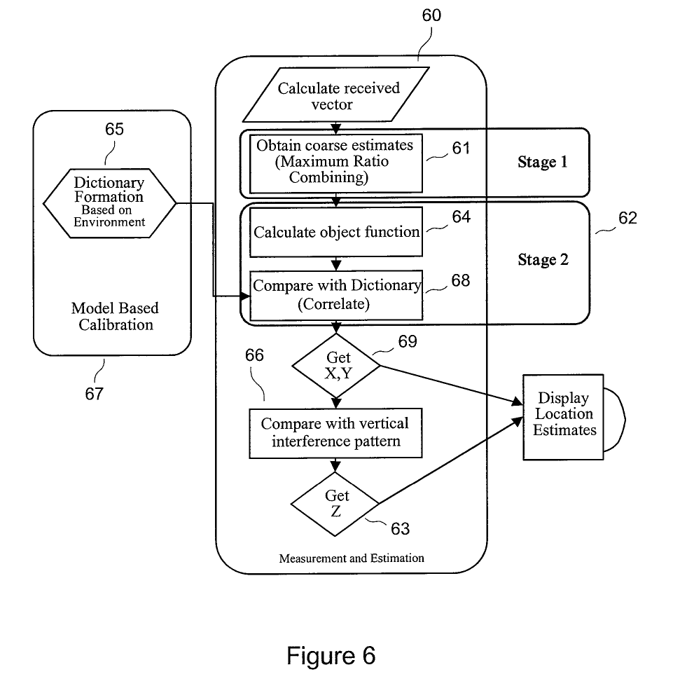

FIG. 6 shows a flow chart of the methodology of such a correlation-based detection and location algorithm in accordance with an embodiment of the present invention. The proposed correlation process consists of a multi-stage algorithm. The stages mimic large scale fading and small scale fading models.

The location of the beacon 34 is first estimated 61 based on the measured received signal strength indicator (RSSI) of the beacon 34 having an unknown location within the grid. In this first stage, the antenna array 23 is used as a diversity combiner in that the phase components are ignored so that the amplitudes of the orthogonal modes are added without risk of fade or cancellation to provide an initial metric of the distance of the beacon 34 along the aisle 26,28 from the antenna array 23. At this stage, diversity combining techniques, such as maximum ratio combining or equal gain combining can be applied to the received signal. This provides a robust RSSI that is used to obtain a course location estimate in the x-coordinate. The beacon 34 can usually be tracked within 5 m accuracy at the end of the first stage 61.

In the second stage 62, deterministic propagation models 67 are used to obtain a finer resolution in (x, y, z). The area, spanned by a notional lateral dimension, for example, 5 m, to which the beacon 34 has been segregated during the first stage 61, is divided into a two-dimensional bracketing grid of desired dimension in (x,y).

An object function 64 for the current location of the beacon 34 is calculated and applied to the signal captured by the antenna array 23 and corresponding to the beacon 34.

There are several options in the design of such a function. However, whichever options are chosen, the object function 64 satisfies an object mapping between the grid elements and the outputs. Some examples of suitable object functions include beamformer outputs or a covariance matrix of the received signals at each antenna element. Those having ordinary skill in this art will readily recognize other possibilities for suitable object functions without departing from the spirit and scope of the present invention.

Using the deterministic model of the second stage 62 described above, an anticipated response generated in accordance with the object function is stored for each grid point. If the exercise is performed after application of the first stage 61, the anticipated response may optionally be calculated on the fly using the object function 64 as applied to the centre of grid elements defined about the coarse estimate of the beacon's 34 position. Preferably, however, the grid elements correspond to universal grid elements defined a priori for the aisle 26,28, such that those pre-defined grid elements that bracket the initial coarse estimated location of the beacon 34 will be identified as the chosen two-dimensional grid about the beacon 34. In this fashion, the anticipated responses for each grid element would be calculated a priori as well. In either event, a dictionary 65, comprising the set of anticipated responses generated by application of the object function 64 to the grid elements in the bracketing grid, is maintained. The previously stored dictionary 65 components for each grid point are correlated 68 with the instantaneously-obtained object function 64 of the current location of the beacon 34 in order to estimate its position in (x,y) 69 with an accuracy based upon the size of each grid point but preferably less than 1 m.

Because the dictionary 65 is populated with pre-calculated, rather than pre-measured responses, a higher correlation 68 may be obtained between the object function 64 of the current position of the beacon 34 and the dictionary 65 entries, as noise effects can be discarded. This in turn permits the grid element size to be reduced, resulting in greater precision.

The size of the grid element may be further reduced if, rather than a single radio frequency, a plurality of frequencies is used, because the response of the object function 64 will presumably vary according to the frequency of the radio wave. As indicated, it is contemplated that a preferred embodiment of the present invention may be implemented using the Wi-Fi pilot tones of a wireless device operating as a beacon 34 in a secondary capacity.

Preferably, the object function 64 used for the z-coordinate 63 is the stimulated vertical interference pattern 66. The accuracy of this estimate of height in the z-coordinate 63 is usually much less than 1 m.

Optionally, the estimates of (x, y, z) may be further refined by using interference patterns set up in each of (x, y, z). Because such interference patterns fluctuate significantly in response to small changes of position, they can be used to good effect to precisely lay down the position of the beacon 34. Ambiguities in terms of adjacent nulls can usually be resolved by considering a plurality of frequencies.

Those having ordinary skill in this art will readily recognize that the relatively simple processing involved means that measurements may be taken at a sufficient repetition rate, with even basic computer power, so as to track even fast-moving beacons 34. For example, with a 4-element array, it is estimated that measurements could be processed within 0.25 ms. If we assume a grid point dimension of 0.3 m in (x, y), this corresponds to a notional ability to track movement of up to 43.2 km/hr, subject of course to accounting for post-Doppler processing. Nevertheless, it is apparent that multiple beacon 34 scenarios should be well within the capabilities of the inventive technique.

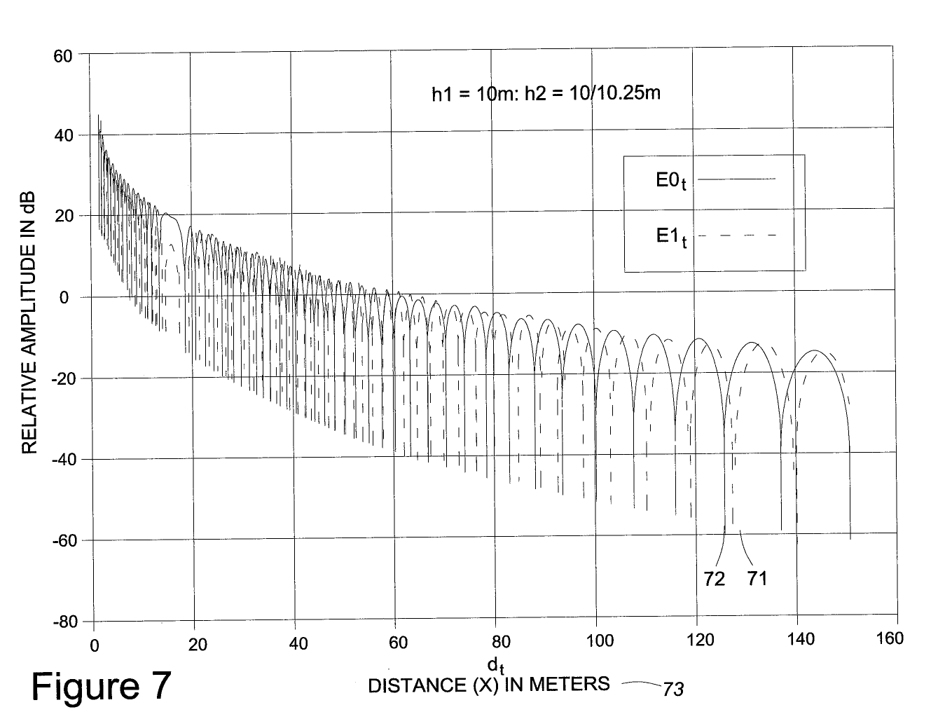

FIGS. 7 through 11 show the application of interference patterns as a preferred object function for the z-coordinate 63 and as a secondary object function 64 to provide finer estimates in (x, y, z) after the initial application of an objection function 64 for all coordinates.

FIG. 7 shows a plot of the application of Equation (4), expressed in dB, to an exemplary scenario for antenna beacon 34 heights 10 m 71 and 10.25m 72 in which the distances D 73 are varied from 150 m down to 1 m. In this figure reflections from the shelving 12 have been ignored in order to simplify the diagram. As can be seen, the two patterns are shifted in the y-direction with respect to one another and readily separable as the beacon height or frequency is varied, suggesting that the differences in the direction are easily discernable for this sub-meter accuracy from the generated interference patterns.

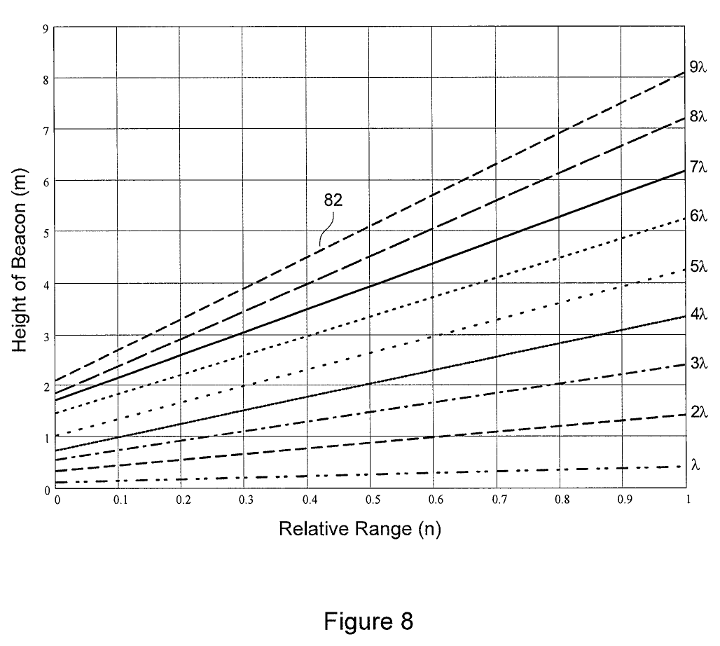

FIG. 8 is a plot of the loci of points as a function of beacon range and height in the exemplary scenario modeled by FIG. 7, where the direct and indirect signals are in anti-phase with respect to one another. Again, the Figure is a simplified representation, as the shelf reflections are ignored. These curves show contours of constant phase 82 difference modulo 180°. Whenever the position in (x, z) of the beacon 34 falls on one of the contours, there is a null in the interference patterns. It may be seen that the nulls may only be experienced by moving the beacon 34 in both the x- and z-directions.

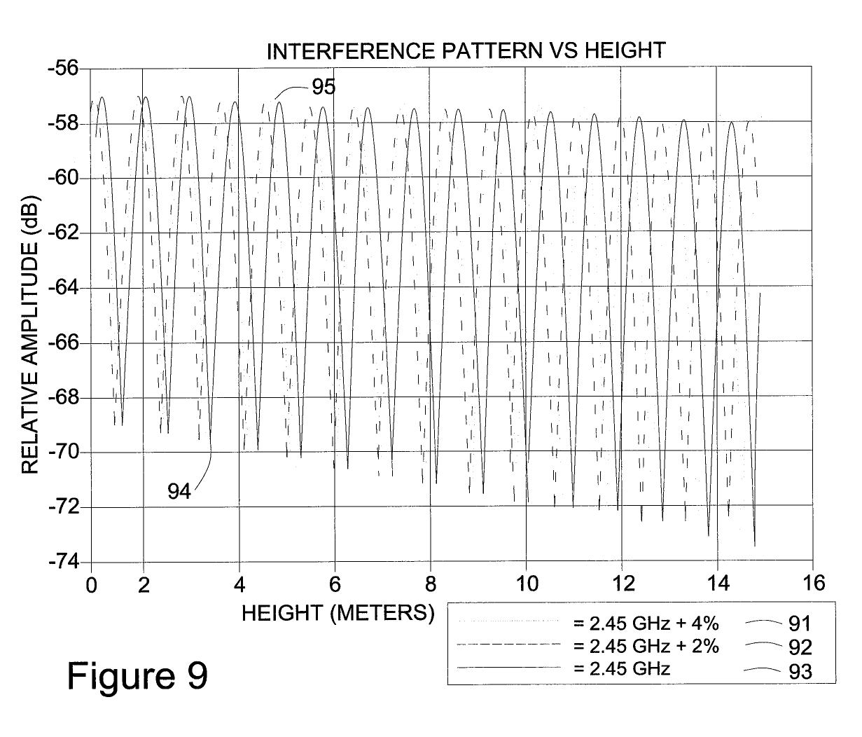

In FIG. 9, there are shown interference patterns corresponding to changes in height (i.e., in the z-direction) only in the exemplary scenario modeled by FIG. 7. In the exemplary scenario depicted therein the range is kept constant at 150 m. The resulting patterns were calculated for three frequencies (k) separated by 1.8%. There is a noticeable shift or displacement in the locations of the peaks 95 and troughs 94 of the interference patterns with frequency change. This variation in frequency is used to resolve the ambiguity in the estimate of the height z of the beacon 34.

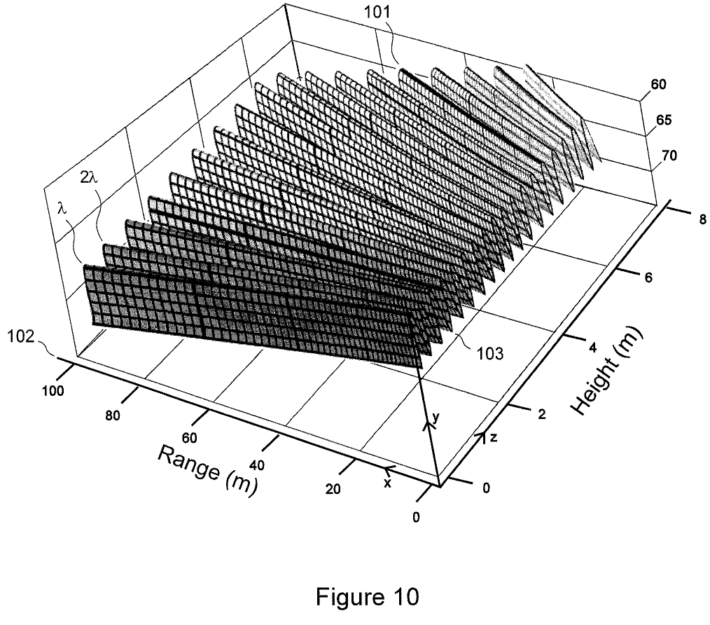

FIG. 10 shows, as a three-dimensional graph, the interference patterns corresponding to the exemplary embodiment modeled by FIG. 7, in (x, z). It may be seen that the amplitude 101 falls off exponentially along the x-direction 102 and the separation 103 between the peaks of the interference pattern increases along the x-direction 102 so that matching the peaks and nulls in the interference patterns serve as highly-accurate primary (in the z-direction) and secondary object functions.

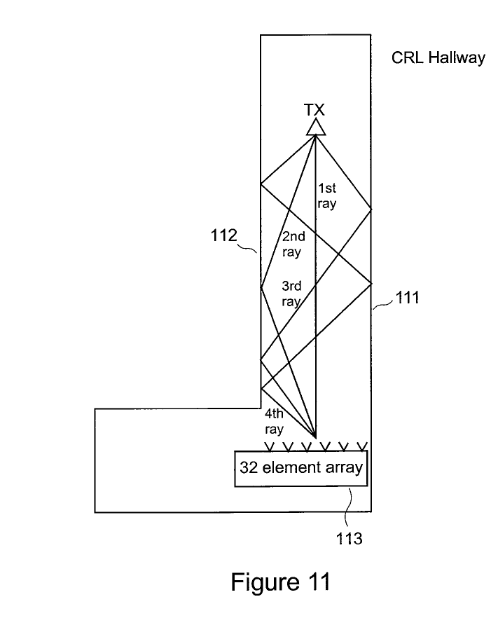

In FIG. 11, an experimental layout down a hallway of McMaster University, Hamilton, Ontario, is shown. The outer walls 111 were composed of concrete block, while the inner walls 112 were composed of drywall sheeting. A 32-element smart antenna 113 was used to carry out measurements. The spacing between the elements of the antenna array 23 was 2λ and synthetic aperture techniques were used to increase the number of effective elements to 128, which reduced the inter-element spacing to λ/2. The frequency of the antenna array 23 was able to jump in 4 MHz steps and encompass a total bandwidth of 88 MHz.

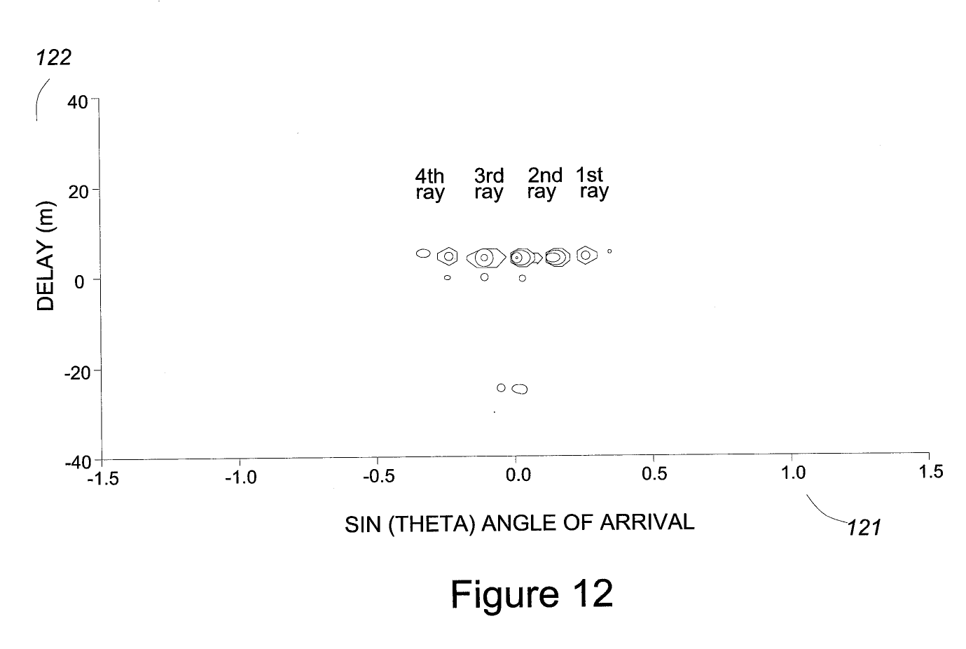

In FIG. 12 the experimental results are shown. Based upon the size of the antenna aperture and its non-instantaneous bandwidth, the accuracy of the antenna array 23 measurements was 1 degree in AOA 121 and 1 metre in time of flight 122.

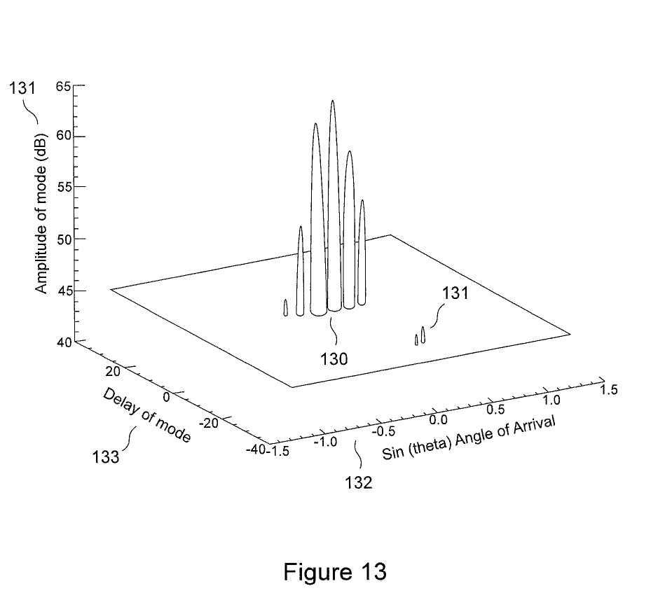

FIG. 13 shows a plot of the power delay 133 and AOA 132 measured by the antenna array 23 in the experimental layout of FIG. 11. Six or seven orthogonal propagation modes may be identified 130. The echoes, identified as long delay echoes 131, are caused by those signals that propagate down the hallway, travel past the antenna array 23 and are reflected by the end-wall, whereupon they travel back down the hallway until they encounter the other end wall, at which point they are reflected down toward the antenna array 23 once again and are received by the antenna array 23.

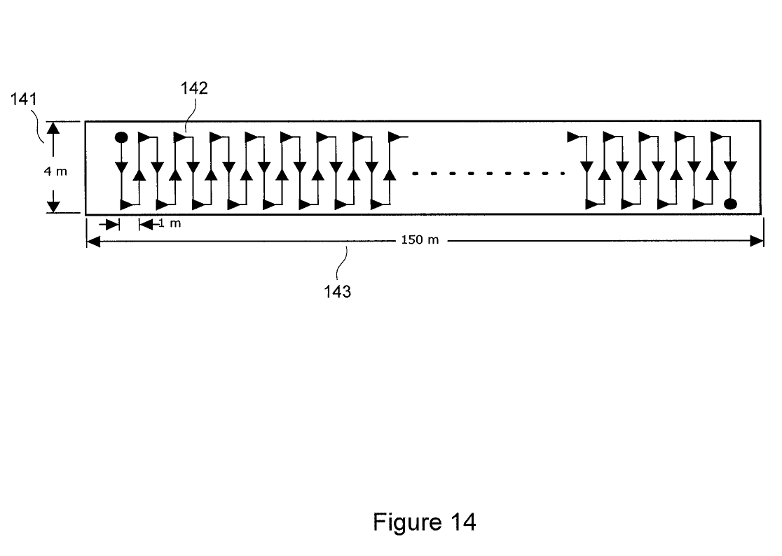

In FIG. 14, there is shown an exemplary path 142 that may be followed by a beacon 34 in a longitudinal aisle 26 of a warehouse. A simulation was carried out using this exemplary path. The aisle width 141 (y-direction) is assumed to be 4 m and the length of the aisle 143 (x-direction) is assumed to be 150 m.

A 4-element antenna array 23 is placed at y=2 m, x=0 m. The inter-element distance of the array was set to λ. The beacon SNR is assumed to be 10 dB with normalized path loss. The beacon 34 follows the plotted path, with 1 m increments taken in both the x- and y-directions. That is, the grid granularity is 1 m×1 m.

The dielectric constant of the shelving material is assumed to be 3, but uniformly distributed in the interval [2,4]. A uniformly distributed phase noise in the range of [−5°, +5°] was added on top of the received signals.

At each location, 100 snapshots of the received signal are taken in order to calculate the object function 64. The covariance matrix formed from the received signal samples at the antenna array 23 was used as the object function 64 in (x,y) in the simulation.

In operation, only one snapshot is required of the beacon 34. Multiple snapshots are preferred to reduce the effects of noise, but at all times, care must be taken to ensure that each snapshot taken records the same position of the beacon 34. Given the scenario of tracking beacons 34 affixed to forklifts 14 and/or inventory, it is unlikely that this cannot be met. Rather, it is more likely that the bottleneck in terms of taking multiple snapshots will be the switching period of the antenna array 23 and/or its filters.

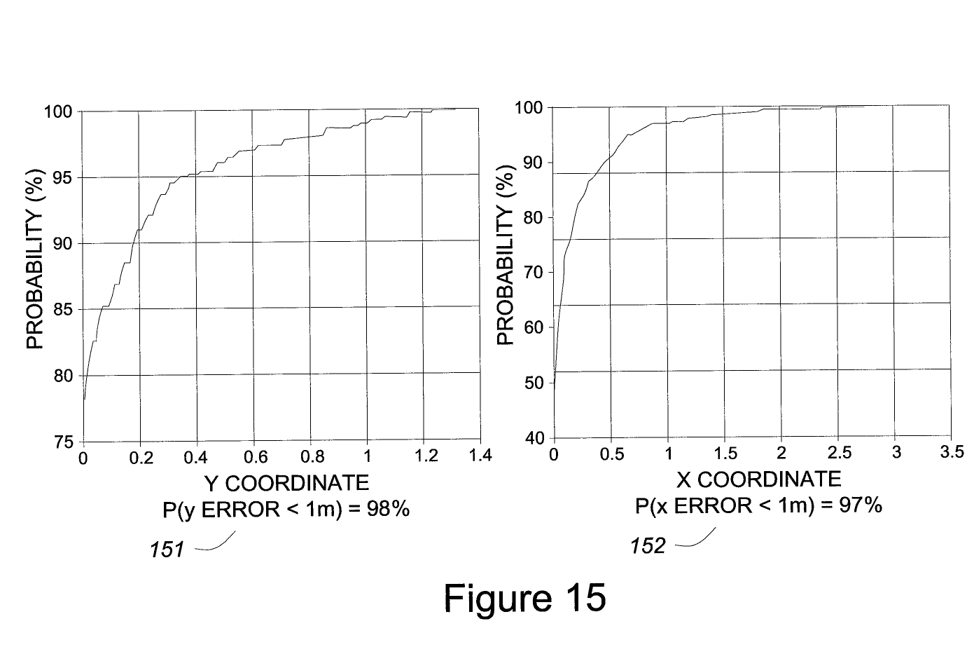

FIG. 15 shows the cumulative probability distributions for error in (x,y). The simulation suggests that the probability of the error in the y-direction 151 being less than 1 m (that is, within the correct grid element) is 98% and in the x-direction 152 as being 97%.

The estimation error for the z-parameter is shown below. This estimate was derived following the estimates in (x,y) and can be seen to be typically less than ⅓ of a meter.

TABLE 1

| RSSI resolution | Z-parameter estimation error |
|---|---|
| ±1 dB | 0.075 m |
| ±2 dB | 0.16 m |
| ±3 dB | 0.24 m |
| ±4 dB | 0.35 m |
| ±5 dB | 0.39 m |

The inventive technique may be applied to warehouses as described above. In such an environment, the technique need not be limited to tracking beacons mounted on vehicles such as forklifts and carts, but may equally be applied to locating and tracking items of merchandise, whether in storage on one of the shelves or in transit from arrival at the warehouse, to a distribution centre and eventually to a shelf. Moreover, suitably marked items such as cellular phones, PDAs and the like may also be located and tracked in accordance with the inventive technique.

Still further, those having ordinary skill in this art will readily recognize that the inventive technique may similarly be applied in shopping malls and stores, which often have similar topologies of aisles.

In the preferred embodiment of using existing wireless devices as beacons, the associated Wi-Fi pilot tones may act as the active signal received by the antenna array. In such a circumstance, a watchdog or similar timer would force a wireless transmission by the device if a pre-determined period of non-transmission had been exceeded, in order to ensure there were sufficient transmissions to perform the radio-location function.

Still further, in dense urban environments, wireless devices such as cellular phones might act as active beacons whose signals are received at antenna arrays mounted along building walls, to provide an effective yet relatively inexpensive location mechanism in such environments, having an accuracy approximating if not improving upon that of the civilian geosynchronous satellite-based Global Positioning System (GPS).

The present invention can be implemented in digital electronic circuitry, or in computer hardware, firmware, software, or in combination thereof. Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

If, as is contemplated, the inventive technique makes use of the prior implementation of a Wi-Fi network, the system implementing the technique could be extended to permit the transmission of information back and forth between the beacon and the antenna array. The use of a MIMO structure as contemplated herein permits the use of the orthogonal modes to transmit multiple independent data streams, thereby creating more usable spectrum.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in ASICs (application-specific integrated circuits).

Examples of such types of computers are the processors contained in or associated with the antenna array shown in the figures, suitable for implementing or performing the apparatus or methods of the invention. The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

For example, in a shopping mall or office, the orthogonal mode structure is less apparent than in the case of a warehouse, but it still exists and can be used for radio location. The methodology used for radio location in these cases is the same as that used in the case of a warehouse.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for accurately determining a location of an object in an aisle, the aisle being defined by a plurality of surfaces, the system comprising:
an antenna array located proximate to the aisle;
a beacon coincident with the object, for directing a radio signal to the antenna array along at least one path that reflects off at least one of the surfaces at a grazing angle that is less than a maximum grazing angle, to form, with a path extending directly from the beacon to the antenna array, a plurality of orthogonal modes;
a processor operatively coupled to the antenna array, for determining the location of the beacon by:
(a) dividing at least a portion of the aisle into a grid of elements;
(b) applying an object function to the orthogonal modes received by the antenna array from the beacon;
(c) for each element in the grid:
i. calculating a signal that approximates a plurality of orthogonal modes that would be received by the antenna array if the beacon were situated within the element;
ii. applying the object function to the calculated signal for the element; and
iii. correlating the object function of the received orthogonal modes with the object function of the calculated signal for the element;
(d) identifying the element for which the object function of the calculated signal corresponding thereto most closely correlates with the object function of the received orthogonal modes; and
(e) determining the location of the object to be within the boundaries of the identified element of the grid.

2. The system according to claim 1, wherein the surfaces defining the aisle comprise a floor extending between two substantially parallel vertical structures.

3. The system according to claim 2, wherein the surfaces further comprise a ceiling.

4. The system according to claim 1, wherein the surfaces appear smooth to radio wave frequencies at grazing angles below the maximum grazing angle.

5. The system according to claim 1, wherein the grid extends along three axes.

6. The system according to claim 1, wherein the aisle comprises a warehouse aisle.

7. The system according to claim 6, wherein the object comprises a forklift.

8. The system according to claim 7, wherein the beacon is affixed to the bottom of the lift portion of the forklift.

9. The system according to claim 6, wherein the object comprises warehouse stock.

10. The system according to claim 1, wherein the aisle comprises a street.

11. The system according to claim 10, wherein the object comprises a wireless handset.

12. The system according to claim 2, wherein the antenna array is mounted at a distal surface from the floor.

13. The system according to claim 1, wherein the antenna array is located at an end of the aisle.

14. The system according to claim 1, wherein the antenna array comprises a plurality of elements.

15. The system according to claim 14, wherein the antenna array comprises a 4×1 element array.

16. The system according to claim 14, wherein the antenna array comprises a 4×4 element array.

17. The system according to claim 1, wherein the beacon generates the radio signal.

18. The system according to claim 17, wherein the beacon is an RFID tag.

19. The system according to claim 17, wherein the beacon is a wireless data terminal.

20. The system according to claim 1, wherein the beacon reflects a radio signal incident thereon from a radio source.

21. The system according to claim 1, wherein the radio signal comprises a plurality of frequencies.

22. The system according to claim 21, wherein at least one of the frequencies is selected from the set of Wi-Fi pilot tones.

23. The system according to claim 1, wherein the elements in the aisle are pre-defined.

24. The system according to claim 1, further comprising a pre-processor for establishing an estimated location of the object.

25. The system according to claim 24, wherein the grid is a sub-set of elements bracketing the estimated location of the object.

26. The system according to claim 25, wherein the number of elements along one axis is 5.

27. The system according to claim 1, wherein the element has a dimension along one axis of 1 m.

28. The system according to claim 1, further comprising a post-processor for developing a refined estimate of the object's location.

29. A method for accurately determining a location of an object in an aisle, the aisle being defined by a plurality of surfaces, the method comprising the steps of:
(a) directing a radio signal from a beacon coincident with the object to an antenna array located proximate to the aisle along at least one path that reflects off at least one of the surfaces at a grazing angle that is less than a maximum grazing angle, to form, with a path extending directly from the beacon to the antenna array, a plurality of orthogonal modes;
(b) applying an object function to the orthogonal modes received by the antenna array from the beacon;
(c) dividing at least a portion of the aisle into a grid of elements;
(d) for each element in the grid:
i. calculating a signal that approximates a plurality of orthogonal modes that would be received by the antenna array if the beacon were situated within the element;
ii. applying the object function to the calculated signal for the element; and
iii. correlating the object function of the received orthogonal modes with the object function for the calculated signal for the element;
(e) identifying the element for which the object function of the calculated signal corresponding thereto most closely correlates with the object function of the orthogonal modes; and
(f) determining the location of the object to be within the boundaries of the identified element of the grid.

30. The method according to claim 29, wherein the calculated signal is obtained by applying geometrical optics calculations.

31. The method according to claim 29, wherein the antenna array computes a plurality of beams to receive the orthogonal modes.

32. The method according to claim 29, comprising the step before step (c) of obtaining an estimated location of the object from a received signal strength indicator (RSSI) of the received radio signal.

33. The method according to claim 29, wherein the object function is a beamformer output of the signal at the antenna.

34. The method according to claim 29, wherein the object function is a covariance matrix of the signal at the antenna.

35. The method according to claim 29, wherein the object function is an interference pattern.

36. The method according to claim 29, wherein steps (d)i. and (d) ii. are performed a priori and maintained in a dictionary.

37. The method according to claim 29, further comprising the step of:
(a) applying an interference pattern to refine the estimate of the object's location.

38. A processor operatively coupled to an antenna array located proximate to an aisle, for locating an object in the aisle, the aisle being defined by a plurality of surfaces, comprising:
(a) an allocator for dividing at least a portion of the aisle into a grid of elements;
(b) a receive processor for receiving from a beacon coincident with the object, a radio signal directed to the antenna array along at least one path that reflects off at least one of the surfaces at a grazing angle that is less than a maximum grazing angle, to form, with a path extending directly from the beacon to the antenna array, a plurality of orthogonal modes;
(c) a simulator for calculating a plurality of signals that each approximate a plurality of orthogonal modes that would be received by the antenna array if the beacon were situated within a corresponding one of each of the elements;
(d) a characterizer for applying an object function to the orthogonal modes and each of the plurality of calculated signals; and
(e) a correlator for correlating the object function of the orthogonal modes with the object function of each of the calculated signals and identifying the element for which the object function of the calculated signal corresponding thereto most closely correlates with the object function of the orthogonal modes;
whereby the location of the object is determined to be within the boundaries of the identified element of the grid.

39. A computer-readable medium in a processor operatively coupled to an antenna array located proximate to an aisle, for locating an object in the aisle, the aisle being defined by a plurality of surfaces, the medium having stored tehreon, computer-readable and computer-executable instructions which, when executed by a processor, cause the processor to perform steps comprising:
(a) directing a radio signal from a beacon coincident with the object to the antenna array along at least one path that reflects off at least one of the surfaces at a grazing angle that is less than a maximum grazing angle, to form, with a path extending directly from the beacon to the antenna array, a plurality of orthogonal modes;
(b) applying an object function to the orthogonal modes received by the antenna array from the beacon;
(c) dividing at least a portion of the aisle into a grid of elements;
(d) for each element in the grid:
i. calculating a signal that approximates a plurality of orthogonal modes that would be received by the antenna array if the beacon were situated within the element;
ii. applying the object function to the calculated signal for the element; and
iii. correlating the object function of the received orthogonal modes with the object function for the calculated signal for the element;
(e) identifying the element for which the object function of the calculated signal corresponding thereto most closely correlates with the object function of the orthogonal modes; and
(f) determining the location of the object to be within the boundaries of the identified element of the grid.
